(19) United States
(12) Patent Application Publication
(10) Pub. No.: US 2024/0249014 A1
(43) Pub. Date: Jul. 25, 2024

(54) SYSTEMS AND METHODS FOR DETERMINING A RISK LEVEL OF DATA IN A RESPONSE TO QUERIES TO A DATABASE

(71) Applicant: IMMUTA, INC., College Park, MD (US)

(72) Inventors: Joseph J. REGENSBURGER, Grove City, OH (US); Alfred V. ROSSI, III, Hilliard, OH (US); Sophie STALLA-BOURDILLON, Reggello (IT)

(21) Appl. No.: 18/417,577

(22) Filed: Jan. 19, 2024

Related U.S. Application Data
(60) Provisional application No. 63/480,631, filed on Jan. 19, 2023.

(51) Int. Cl. G06F 21/62; G06F 16/28

(52) U.S. Cl. CPC G06F 21/6227; G06F 16/285

(57) ABSTRACT

A method and system are configured for identifying a risk level of data in a response to a query made to a database. The method may include receiving the query, receiving a framework including data categorization rules for the data, parsing the query to determine queried tables of data elements in the database, classifying the data elements in the queried tables based on rules in the framework to produce classification labelings, jointly classifying a union of data elements in the queried tables to produce classification labelings for the union of data elements, determining a risk level for each of the queried tables by comparing the classification labelings for data elements in each table to the classification labelings in the union of data elements, and presenting a risk level alert for the query when the risk level of any of the queried tables is above a predetermined risk level.

### CROSS-REFERENCE TO RELATED APPLICATIONS

This application claims the benefit of U.S. Provisional Patent Application No. 63/480,631 filed on Jan. 19, 2023, which is hereby incorporated by reference in its entirety.

### FIELD OF THE DISCLOSURE

The techniques herein generally relate to data disclosure, and more particularly, but not exclusively, to systems and methods for determining risk analysis of queries to a database.

### BACKGROUND

Compliance, data governance, privacy and security frameworks (collectively referred to herein as frameworks) are often used to outline protections of data that may need to be implemented by data category in various technologies such as utilized with relational databases. For example, the Payment Card Industry Data Security Standard (PCI DSS) requires additional protections when cardholder names are stored in conjunction with credit card numbers. Data elements in such a Payment Card Industry database may include the categories of cardholder names and credit card numbers, that may be individually less sensitive than they are together.

Such relational databases may be SQL databases that may be configured to store data, to receive queries from outside entities for data, and to respond to such queries. When responding to the queries with releasing of data through a query response, the database may need to configure the query response to comply with one or more of the security frameworks.

Though storing the individually-less-sensitive parts of information separately lowers the risk of disclosure of sensitive data, it paradoxically increases the risk for accidental recombination as the barriers for access of the less-sensitive data may be lower than their combination. As a result, accidental recombination of data often are missed, allowing data that should be off limits for processing without special approval to be processed. It therefore would be useful to be able to discover and report when data processing events, such as generating a response to a database query, exhibits risk exceeding the respective risk levels of all input data when the respective risk levels are considered independently.

Moreover, the rules behind how data designations or classifications change as they appear in combination may be complicated. For example, privacy-oriented regulations such as HIPAA, CCPA, and the General Data Protection Regulation (GDPR) include many noted combinations which can restrict lawful processing. At the same time, the set of applicable regulations varies greatly by industry, making it difficult for operators of databases to process queries to the databases while complying with the rules and regulations.

### SUMMARY

Disclosed herein are systems, methods, and computer program products for identifying a risk level of data in a response to a query made to a database. The method may include receiving, by a computing device, the query, receiving, by the computing device, a framework including data categorization rules for the data, parsing the query to determine queried tables of data elements in the database, classifying the data elements in the queried tables based on rules in the framework to produce classification labelings for the data elements in each of the queried tables, jointly classifying a union of data elements in the queried tables to produce a classification labelings for the union of data elements, determining a risk level R(Q) for each of the queried tables by comparing the classification labelings for data elements in each table to the classification labelings in the union of data elements, and presenting a risk level alert for the query when the risk level R(Q) of any of the queried tables is above a predetermined risk level.

In some embodiments, the systems, methods, and computer program products may generate a differential risk score for each query, and present a risk level alert when the differential risk level is above a predetermined differential risk level.

### BRIEF DESCRIPTION OF THE DRAWINGS

The accompanying drawings, which are incorporated into and constitute a part of this specification, illustrate implementations of the techniques herein and together with the description, serve to explain the principles of various embodiments.

FIG. 1 illustrates a block diagram of an example of an environment for implementing systems and methods in accordance with aspects of the present disclosure.

FIG. 2 shows a system block diagram illustrating an example of a computing system, in accordance with aspects of the present disclosure.

FIG. 3 is a flowchart of a process consistent with implementations described herein.

FIG. 4 is a flowchart of a process consistent with implementations described herein.

FIG. 5 is flowchart of a process consistent with implementations described herein.

### DETAILED DESCRIPTION

Reference will now be made in detail to example implementations of the techniques herein, examples of which are illustrated in the accompanying drawings. Wherever convenient, the same reference numbers will be used throughout the drawing to refer to the same or like parts.

In accordance with embodiments described herein, a system, processes and computer-program products may be configured for identifying a risk level of data in a response to a query made to a database. The methods may include receiving, by a computing device, the query, receiving, by the computing device, a framework including data categorization rules for the data, parsing the query to determine queried tables of data elements in the database, classifying the data elements in the queried tables based on rules in the framework to produce classification labelings for the data elements in each of the queried tables, jointly classifying a union of data elements in the queried tables to produce a classification labelings for the union of data elements, determining a risk level R(Q) for each of the queried tables by comparing the classification labelings for data elements in each table to the classification labelings in the union of data elements, and presenting a risk level alert for the query when the risk level R(Q) of any of the queried tables is above a predetermined risk level.

In accordance with various embodiments, by the system, the administrators of the database do not have to understand how to apply the data transformation, which can be difficult. Moreover, such systems and methods can be used to augment the capabilities of databases which do not offer such features directly in product, including application of the data transformation to meet privacy requirements.

Embodiments may be utilized with disclosure of any type of data where privacy concerns are relevant. However, a particularly salient use case for embodiments occurs within the context of HIPAA Expert Determination of The HIPAA Privacy Rule enforced by the United States Department of Health and Human Services Office for Civil Rights (OCR).

The HIPAA Privacy Rule offers two methods for de-identifying Protected Health Information (PHI): the Expert Determination method (§ 164.514(b)(1)) and the Safe Harbor method (§ 164.514(b)(2)). While neither method ensures zero risk of re-identification when disclosing data, both facilitate the secondary use of data. The Safe Harbor method is often used because HIPAA defines it more precisely and it is thus easier to implement. The Expert Determination method, in contrast, offers more flexibility than the Safe Harbor method but relies upon the expert application of statistical or scientific principles that result in only a very small re-identification risk.

In various embodiments, a higher sensitivity classification of data may be needed when two or more data elements or records are utilized in processing of the data, such as when a query requires two or more data records to generate an answer. For example, consider the following two data records: rec1 and rec2 which come from different data sources. Here, rec1 comes from a table of warehouse addresses while rec2 comes from a table of customers.
rec1={address: “456 Industry Dr.”, warehouseNumber: 7}
rec2={address: “123 Main St.”, lastName: “Smith”, firstName: “John” }

A system attempting automated classification of data elements may perform an initial analysis of each record and correctly decide, due to the format of the values that appear, that address fields contain Street Address Data, while firstName, and lastName, fields both contain Person Name Data. Such preprocessing is common and these kinds of associations are commonly obtained through a process known as Entity Classification.

A problem may arise, however, when trying to ensure the compliant use of data per a privacy framework, such as GDPR, which would conditionally consider Address Data to be Personal Data whenever it pertains to an individual. Correct identification of such fields under GDPR is important, since Personal Data under GDPR comes with additional confidentiality and integrity requirements which may require an elevated sensitivity level to protect sensitive data from being disclosed.

Where automated classification of data in a database is used, the classification system may look for markers that the record pertains to an individual. For example, considering the above data records rec1 and rec2, the presence of firstName and lastName fields could be considered with the following set of rules 1-4:

1. A data element is Address Data whenever it is formatted consistently with Street Address Data.

2. A data element is Personal Data whenever it is consistent with First Name Data.

3. A data element is Personal Data whenever it is consistent with Last Name Data.

4. A data element is Personal Data whenever another data element on the same record is also Personal Data.

In processing rec2 with the above rules, it would be determined that the firstName and lastName fields are Personal Data as they satisfy the condition with having values consistent with First Name Data, and Last Name Data. Furthermore, it follows from such rules that the address field is Personal Data, since it occurred on a record with other fields that had been deemed Personal Data. Therefore, a query that only uses data from rec1 may have a low sensitivity classification, while a query that only uses data from rec2 may have a higher sensitivity classification because it includes personal data.

When an answer to a query requires data from more than one data record or element in a database and each of the data elements individually have a low sensitivity rating, an answer to the query may combine data from the two data records such that the combined data will have a higher sensitivity rating than the individual data elements. Various embodiments disclosed herein are configured to determine when an answer to a query will need to have a higher sensitivity rating than either of the individual data elements, and to generate a sensitivity alarm when the higher sensitivity rating is above a sensitivity rating threshold. This higher sensitivity rating may not be recognized by conventional systems and methods because each of the data records has the low sensitivity rating. This problem can be exacerbated when more than one framework with different rules needs to be utilized in accordance with generating a response to the query.

The embodiments disclosed herein provide an improvement to conventional database technology by providing the disclosed systems and methods that are configured to generate a risk level alert for the query when the risk level R(Q) of any of the queried tables in the database is above a predetermined risk level. This allows a user of the database to automatically receive a risk level alert when a risk level of disclosure of sensitive data occurs, without the user of the database having to know how to determine when an elevated risk of disclosure of sensitive information may occur in response to a query.

As used herein, a Framework may include:
1. a set of Dimensions of Concern (also known as Dimensions)
2. a set of Classification Labels defined under the Framework, and,
3. a set of Classification Rules.

A Classification Label may include:
1. a name,
2. at most one (zero or one) numeric Sensitivity Levels or Values for each Dimension of Concern

Dimensions of Concern as used herein are organizational units signaling the nature of a particular sensitivity, where the nature of particular sensitivity conveys the absolute or relative impact if there is a compromise to that dimension of concern. For example, the GDPR requires that Personal Data be kept in confidence, and that it be accurate. This results in two dimensions of concern under GDPR: confidentiality and integrity. Impact is independently assessed along each of these dimensions, e.g. if data is not kept confidential and if data is inaccurate. This may be encoded in relative the system as indicating that the Personal Data (a Classification Label) has a Sensitivity Value of 1 for the “Confidentiality” Dimension of Concern, and a Sensitivity Value of 2 for the “Integrity” Dimension of Concern. Alternatively it may be encoded in absolute terms, such as financial impact, the system as indicating that the Personal Data (a Classification Label) has a notional Sensitivity Value of $500 for the “Confidentiality” Dimension of Concern, and a notional Sensitivity Value of $1000 for the “Integrity” Dimension of Concern. Any number of classification labels may be included for different classifications of data. For example, a Health Data classification label could be included to classify health data. Each classification label may have a sensitivity level for each dimension of concern. For example, a health data classification label may have a relative sensitivity level or value of 2 for the integrity dimension of concern.

In various embodiments, parts of the system which monitor for framework violations, e.g., an unintentional disclosure of a confidential item, or non-conformant data being added to a field, may use this information in ranking the severity of the violation and to guide subsequent alerting and flagging.

Generally, Dimensions of Concern, are an open set of items, except with the constraint that their use throughout the Framework is limited to only what is declared in the Framework Definition.

Some possible Dimensions of Concern that may be used with various embodiments may include:
Per NIST Security Framework: Confidentiality, Integrity, and Availability.
Per the GDPR: Accessibility, Accuracy, Availability, Confidentiality, Distinguishability, Identifiability, Localization, Minimization, Quality and Relevance, Retention, and Unlinkability.

As used in various embodiments, a Classification Rule may include:
1. the name of the Classification Label to be applied if the Classification Rule is considered satisfied
2. a set of Rule Conditions to be satisfied

In accordance with various embodiments, the Rule Conditions may state requirements including, but not limited to, any additional required Classification Labels a data element must have in partial satisfaction of the Classification Rule, requirements on the presence of Classification Labels appearing on other data elements in the same context, and/or any required Classification Labels directly associated with the context, itself. Rule Conditions may also present other requirements, such as requiring the presence of specific entity classification labels or results; or that they depend on meeting thresholds for certain statistical and/or mathematical measures over the context.

In some embodiments, there is no requirement that Rule Conditions refer only to Classification Labels defined under the Framework Definition of the Rule on which they appear. Rather, they may reference Classification Labels defined under other Framework Definitions. In particular, this allows for the possibility of interactions among frameworks.

For example, a company wishing to map categories of data under GDPR to their own internal compliance framework may freely do so. This is especially useful in cases where a company already has internal controls organized around their internal classifications of data and wish to align external regulatory requirements with whatever internal designations provide protections consistent with regulatory requirements.

In various embodiments, the methods and systems may utilize a Classification Solver that takes a map which associates to each data element in the target context an incomplete set of Classification Labels, together with a collection of Framework Definitions. Through Classification Rule Analysis, the solver derives the full set of Classification Labels for each data element in the data context.

In the operation of the Classification Solver, Classification Rule Analysis efficiently computes a transitively-closed set of Classification Labels under the applicable Framework Definitions.

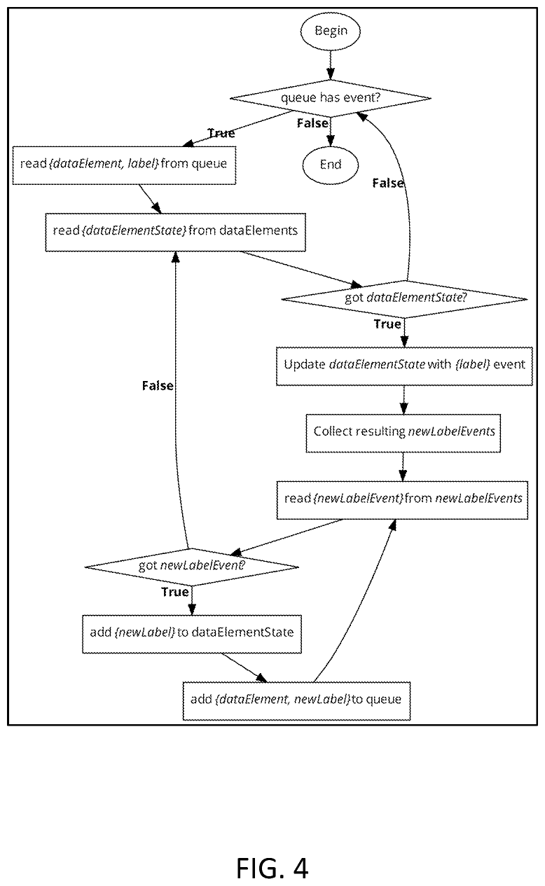

Generally, this is accomplished in accordance with various embodiments by constructing a “global” Rule Graph where each data element possesses a “local” copy of the framework Classification Rules in graph form, with the local graphs coupled together connecting tags and rules on one data element to Rule Conditions on other data elements that are advanced by their presence or production, respectively. Alternatively, this is accomplished in accordance with various embodiments by a procedure illustrated in FIG. 4, which is further explained herein.

### Sensitivity Levels

In accordance with various embodiments, the classification labeling includes sensitivity levels by Dimension of Concern, relative to a fixed framework, and a sensitivity level is determined for each data element. Specifically, given a data element, a Framework, and a specific Dimension of Concern, the Sensitivity of the data element under that framework is the maximum Sensitivity Value of that dimension, taken over all associated Classification Labels that belong to the Framework.

It is also allowed that the Framework specifies zero or more custom Sensitivity Aggregation Functions to be declared in association with each Dimension of Concern:

1. Data Element Sensitivity which determines a sensitivity value for the data element by specifying the aggregation of Classification Label sensitivities for Classification Labels for the target Dimension of Concern under the Framework that are assigned to the target data element.

2. Record Sensitivity specifying the aggregation of Data Element Sensitivity values for the target Dimension of Concern over all data elements in the record.

3. Context Sensitivity specifying the manner of aggregation of Record Sensitivity for the target Dimension of Concern over all records in the context.

In addition to being able to examine input sensitivities, the above aggregation functions may further reference statistics about the data as it appears in one or more contexts.

In accordance with various embodiments, the interpretation of sensitivity under a Framework is left up to the Framework. Among other things, in various embodiments, frameworks may use sensitivity values to communicate:

1. The rank-order of framework classification by their expected impact along various Dimensions of Concern.

2. A liability value per incident involving a given field or record.

3. The amount of information gained by an attacker who observes the field value.

In accordance with various embodiments, framework sensitivities may be used to facilitate domain specific risk evaluations. For example, HIPAA liability information can be used to bound the (per-record) liability of HIPAA disclosure.

### Risk Measures

Risk Measures are similar to Sensitivity Aggregation Functions, but sit at a higher level than Frameworks and may take into account multiple Dimensions of Concern under various Frameworks, as well as other statistical and/or mathematical measures made available by the system.

For instance, consider the above HIPAA liability example where the Record Sensitivity encodes the maximum liability for accidental disclosure, and direct identifiers have been removed from the data. In such a setting the number of records re-identified by an attacker performing a guessing strategy is related to the number of distinct groups that exist when projected onto demographic values. By supplying the number of distinct groups, a Risk Measure may combine this with the HIPAA liability cap encoded in Record Sensitivity information to give an upper bound on the expected liability, roughly as a function of how well k-anonymized the data happens to be. Further rules may indicate under which conditions a system should flag a processing activity or send an alert.

### Differential Query Sensitivity and Risk

Because classification is context-specific, it can happen that two otherwise benign data inputs are combined in some way (perhaps joined in a database) into something that has a higher overall sensitivity. For example, this may occur under PCI DSS when cardholder name data is accessed together with the credit card number. When these items appear in separate database tables, their respective sensitivities are relatively low. However, if joined together, the sensitivity level of the data processing activity which joins the data (and its output data) exceeds the sensitivities of the respective tables. Embodiments disclosed herein determine when a sensitivity level of processed data has a higher sensitivity than the individual data elements. If the higher data sensitivity is above a predetermined level, then the embodiments generate a sensitivity alarm to prevent disclosure of the sensitive data, as further described herein.

In accordance with various embodiments, systems and methods herein may perform a Differential Query Sensitivity Assessment (and, similarly, Differential Query Risk Assessment), which is the process of doing a comparative assessment where sensitivity (or risk) assessed in the data processing activity context is compared to the same assessment run on each of its respective inputs. If data processing activity context comes in higher than all of its respective inputs, then the processing activity can be understood to have implications with respect to the active frameworks.

In some embodiments, a high sensitivity classification level may be lowered by suppressing part of the input data from being used in the data processing context. Such a lowering indicates effective data protection efforts.

In accordance with various embodiments, sensitivity (and/or risk) analysis in the data processing context may be further lowered due to the specific flow of information. For example, it's possible that only certain insensitive fields are transformed or used. As such, data classification labels and sensitivities propagated through the data processing activity may take into account processing. This is useful in accounting for inputs which are unused in the processing activity, and therefore do not contribute to the sensitivity of the output, as well as sensitive values which are transformed in such a way that that renders them less (or in-)sensitive.

### End-to-End Differential Risk Analysis Workflow in a Database

In accordance with various embodiments, the systems and methods disclosed herein may be configured for computing, displaying, sorting, and surfacing queries by risk level. In these system and methods, the text of a database query, Q, is received by a computing device, which may or may not be different from the database system performing Q. The query, Q, is parsed to obtain a list of queried tables T1, T2, . . . , Tn. In a first pass, Classification is performed by invoking a Classification Solver, configured with a set of rules, on each of T1, T2, . . . , Tn. Here, each table of data elements is assumed to already have some (possibly empty) set of Entity Classification labels associated with its data elements, resulting in (per data element) Classification labelings L1, L2, . . . , Ln corresponding to each table.

Next, either a coarse or fine-grained classification is performed. In the coarse approach, Classification is jointly performed over the full set of queried tables, simultaneously. That is, over the union of the data elements of T1, T2, . . . , Tn. In the fine-grained approach, the transformation of data in the evaluation of the query is processed to remove Classification Labels if the query eventually discards, sufficiently dilutes, or would otherwise render the data safe (e.g., by masking). In some embodiments, the query Q is converted to a query plan PQ which is a graph modeling the evaluation of Q.

Classification Labeling information, Ti[f], for each data element, f, utilized in query evaluation, is transported along its corresponding path in PQ with the Classification Label changing according to how data is combined, removed, or otherwise transformed. This is propagated all the way through to label each column as appearing in the evaluation of Q.

Next the resulting set of Classification Labels from the previous step are compared to the Classification Labels derived from the individual query inputs previously computed. In this step, the complete set of Risk Measurement values (utilizing the sensitivity information along (a possible subset of) each dimension of concern) are computed for the output set, resulting in R(Q), as well as for each input T1, T2, . . . , Tn, resulting in R(T1), R(T2), . . . , R(Tn).

A Differential Risk Score, such as Δ_R (Q)=R(Q)−Max(R(T1), R(T2), . . . , R(Tn)), is calculated for each risk measurement. In a generating step, Differential Risk Scores are evaluated per alerting rules to establish or alter the displayed risk levels associated with Q. Per alerting rules, and for each risk measure R such that Δ_R (Q)>t_R, where tR is some configurable threshold, notifications and/or alerts may be generated expressing the discovery that query Q potentiates risk R beyond a tolerance threshold tR. Dispatched alert and notification channels are configurable, including, e.g, but not limited to logging systems, Auditing systems, external security analysis tools, Chat, Email, and SMS services.

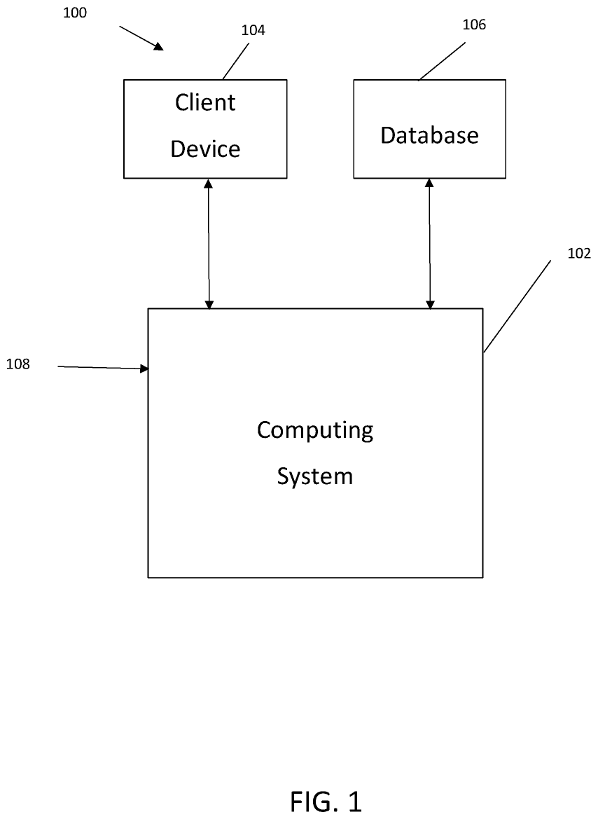

FIG. 1 illustrates a block diagram of an example of a system or an environment 100 for implementing systems and methods in accordance with aspects of the present disclosure. The environment 100 may include a client device 104, a computing system 102 and a database system 106 (also called simply database 106), which in some embodiments may be an SQL database. In some embodiments, the client device 104 may be a computing device.

In one usage example, a user (not shown) may use the client device 104 to send a query, such as a database query (e.g., a request for data from a database, such as SELECT Sex, AVG(Salary) FROM Salaries GROUP BY Sex) to the computing system 102, which may be configured to provide the results to the query. Computing system 102, in accordance with aspects of the present disclosure, may be configured determine a risk level for a query to a database based on the categorization rules of one or more applicable frameworks, as further described herein.

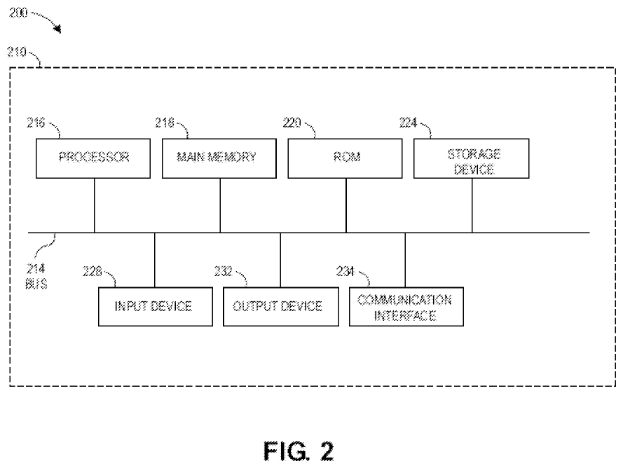

FIG. 2 shows a system block diagram illustrating an example of further details of the computing system 102 of FIG. 1, illustrated as computing system 200, in accordance with aspects of the present disclosure. As shown in this example, the computing system 200 may include a computing device 210 capable of communicating via a network, such as the Internet. In example embodiments, the computing device 210 may correspond to a mobile communications device (e.g., a smart phone or a personal digital assistant (PDA)), a portable computer device (e.g., a laptop or a tablet computer), a desktop computing device, a server, etc. In some embodiments, the computing device 210 may host programming and/or an application(s) to carry out the processes, methods, functions, or operations as described herein. For example, the computing device 210 may be configured to receive and/or obtain a database query 112 via its communications interface 234.

The computing device 210 may include a bus 214, a processor 216, a main memory 218, a read only memory (ROM) 220, a storage device 224, an input device 228, an output device 232, and a communication interface 234, as shown in this example.

The bus 214 may be or include a path that permits communication among the components of the computing device 210. The processor 216 may be or include a processor, a microprocessor, an application specific integrated circuit (ASIC), a field programmable gate array (FPGA), or another type of processor that interprets and executes instructions. The main memory 218 may include a random-access memory (RAM) or another type of dynamic storage device that stores information or instructions for execution by the processor 216. The ROM 220 may be or include a static storage device that stores static information or instructions for use by the processor 216. The storage device 224 may include a magnetic storage medium, such as a hard disk drive, or a solid state memory device, which may be removable, such as a flash memory.

The input device 228 may include a component(s) that permits an operator to input information to computing device 210, such as a control button, a keyboard, a keypad, a mouse, a microphone, a touchscreen, or another type of input device. The output device 232 may include a component(s) that outputs information to an operator or user, such as a light emitting diode (LED), a display, a monitor, a touchscreen, or another type of output device. The communication interface 234 may include any transceiver-like component that enables the computing device 210 to communicate with other devices or networks. In some implementations, the communication interface 234 may include a wireless interface, a wired interface, or a combination of a wireless interface and a wired interface. In embodiments, the communication interface 234 may receive computer readable program instructions from a network and may forward the computer readable program instructions for storage in a computer readable storage medium (e.g., storage device 224, main memory 218, etc.).

The system 200 may perform certain operations, as described in detail herein. The system 200 may perform these operations as, or in response to, the processor 216 executing software instructions contained in a computer-readable medium, such as the main memory 218. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into the main memory 218 from another computer-readable medium, such as the storage device 224, or from another device via communication interface 234. The software instructions contained in the main memory 218 may direct the processor 216 to perform the processes, methods, or operations that are described in greater detail herein. Alternatively, hardwired circuitry may be used in place of or in combination with software instructions to implement processes, methods, or operations described herein. Thus, implementations described herein are not limited to any specific combination of hardware circuitry and software.

In some implementations, the system 200 may include additional components, fewer components, different components, or differently arranged components than are shown in FIG. 2.

The system 200 may be connected to a communications network (not shown), which may include one or more wired and/or wireless networks. For example, the communications network may include a cellular network (e.g., a second generation (2G) network, a third generation (3G) network, a fourth generation (4G) network, a fifth generation (2G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the communications network may include copper transmission cables, optical transmission fibers, wireless transmission, routers, firewalls, switches, gateway computers and/or edge servers.

The computing device 210 shown in FIG. 2 may be configured to receive or obtain a database query and provide a risk level alert when a determined risk score for the query is above a risk level threshold, among other functions, as further described herein.

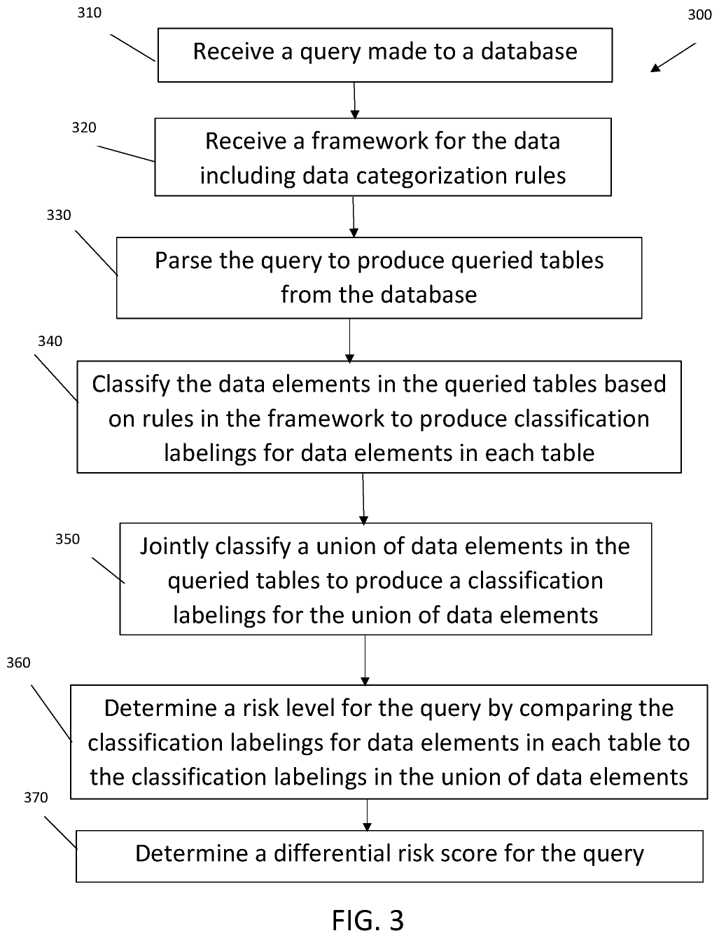

FIG. 3 illustrates an example of a process or method 300 that may be carried out by systems and methods described herein, configured to prevent disclosure of sensitive data having a risk level above a risk level threshold, consistent with embodiments of the invention. The process 300 begins in 310 by the computing device 102 receiving a query directed to the database 106. The query may be received at the computing device 102 from the database 106, or the computing device 102 may receive the query directly from the client device 104. In various embodiments, the query may be an SQL query.

In 320, a framework, including data categorization rules for the data in the database 106, is received by the computing device 102. The framework may include elements other than the data categorization rules. In some embodiments, more than one framework may be received by the computing device 102, and each of the frameworks may have different categorization rules.

In 330, the query is parsed to obtain a list of list of queried tables T₁, T₂, . . . , Tₙ from the database 106.

In 340, classification is performed on the data elements in the queried tables based on rules in the framework to produce classification labelings L1, L2, . . . , Ln for the data elements in each table. In 340, one or more than one set of rules may be utilized to perform the classification.

In 350, the computing device 102 may jointly classify a union of data elements in the queried tables to produce classification labelings for the union of data elements.

In 360, the computing device 102 may determine a risk level for the query by comparing the classification labelings for data elements as determined in 340 to the classification labelings of the union of data elements as determined in 350 and as further described herein.

In 370, a differential risk score may be determined for the query. In some embodiments, if the differential risk score is above a predetermined risk score value, a risk alert may be provided. The risk level alert may be provided in the form of a message, such as an email, a chat message, an SMS message, etc.

### EXAMPLE

Various embodiments disclosed herein may perform according to the following medical informatics example involving accidental re-identification of seemingly de-identified patient medical chart information. In this scenario, there are two tables of data, one containing patient demographic identifiers (PATIENT_INFORMATION), and another containing a limited collection of lab values (PATIENT_LABS), but is free of the 18 kinds of identifiers specified under HIPAA Safe-Harbor (45 CFR § 164.514(b)(2)) and therefore, on its own, is not deemed patient health information (PHI) under HIPAA. The two tables share a common join key on the ID columns, as follows:

### Patient Info:

ID (UUID, INTERNAL_IDENTIFIER): A unique identifier for each patient.
Name (String, DIRECT_IDENTIFIER): The full name of the patient.
DOB (Date, INDIRECT_IDENTIFIER): Date of birth of the patient.
Address (String, INDIRECT_IDENTIFIER): Home address of the patient.
Gender (String, INDIRECT_IDENTIFIER): Gender of the patient.

In this example the datatype of the column is specified within the paranthesis. In this example datatypes include universal unique identifiers (UUID), strings, and dates. More broadly these datatypes could include numeric data, boolean values, semi-structured data (such as JSON or YAML formatted data), binary data, or other datatypes supported by the underlying database. In addition, the second item in the parenthesis denotes the strength of the potential for an attribute to identify an person. An indication of INTERNAL_IDENTIFER means an attribute uniquely identify a person, but have not extrinsic meaning outside of the database. DIRECT_IDENTIFIER indicator means that the attribute has a strong potential to directly be associated with an individual, and carries extrinsic meaning, making the risk to confidentiality high. An indication of INDIRECT_IDENTIFIER also carries extrinic meaning, but has a smaller potential to re-identify an individual. Examples of indirect identifiers include gender, sex, date of birth, etc. Each of these can be associated with a large population of people, and can provide additional marginal risk of re-identification. Practically this means the re-identification risk will increase with more indirect identifiers. Finally an SENSITIVE indicator, conveys that the data may not have strong potential to re-identify an individual, given that it is unknown, but it's public disclosure could increase the impact if a SENSITIVE attribute is disclosed at the same time identifiable information is disclosed.

### Patient Labs:

ID (UUID, INTERNAL_IDENTIFIER): A unique identifier matching with the PATIENT_INFO table.
LabTest (String, SENSITIVE): The type of lab test performed (e.g., CBC, Lipid Panel).
TestDate (Date): The date when the lab test was performed.
Result (String, SENSITIVE): The result of the lab test.

The system receives a query, Q, equaling

```
    SELECT PI.Gender, PL.ID, PL.LabTest, PL.TestDate, PL.Result
      FROM PATIENT_INFO PI
      JOIN PATIENT LABS PL ON PI.ID = PL.ID;
```

The system parses the query Q, extracting the table names of PATIENT_INFO (aliased as PI) and PATIENT_LABS (aliased as PL). The system individually and separately runs identification for each of the two tables. With respect to the first table, the system runs classification on:

```
PATIENT_INFO:{
  ID: [INTERNAL_IDENTIFIER],
  Gender: [INDIRECT_IDENTIFIER]
}
```

and determines that the PATIENT_INFO table contains PII, and therefore has a sensitivity of 1. Separately, the system runs classification with respect to the second table and determines that PATIENT_LABS contains SENSITIVE, which on its own has a sensitivity of 1.

```
PATIENT_LABS: {
  LabTest: [SENSITIVE],
  Result: [SENSITIVE],
}
```

In a coarse-grained classification, both of the previous sets of classification metadata are submitted together,

```
[
PATIENT_INFO: {
ID: [INTERNAL_IDENTIFIER],
  Gender: [INDIRECT_IDENTIFIER]
},
PATIENT_LABS: {
  LabTest: [SENSITIVE ],
  Result: [SENSITIVE ],
}]
```

and metadata are submitted together. The resulting combination of PII and SENSITIVE results in a determination of PHI which, per the rules, has a sensitivity of 2. As a result, query shown in will have a higher sensitivity than the individual tables which feed the result. FIG. 4 illustrates an alternative method of computing a transitively-closed set of Classification Labels under the applicable Framework Definitions

One of ordinary skill will recognize that the components, arrangement, and implementation details of the computing system 210 are examples presented for conciseness and clarity of explanation. Other components, implementation details, and variations may be used, including adding, combining, or subtracting components and functions.

FIG. 4 is an example process flow diagram of a method for computing a transitively-closed set of Classification Labels under the applicable Framework Definitions. The queue is seeded with Label Events corresponding to the initial labeling (those Classification Labels already present on data elements) as being added to their respective data elements.

In a generic step, execution proceeds by removing an element from the queue and updating the state of any other data elements which make progress towards gaining a label through the occurrence of this label event.

Rules completed through the generic step result in the new association of a Classification Label to a data element through updating the solver state for a given data element to include new Classification Labels. Newly associated Classification Labels are added back to the queue, and this process continues until the queue is empty.

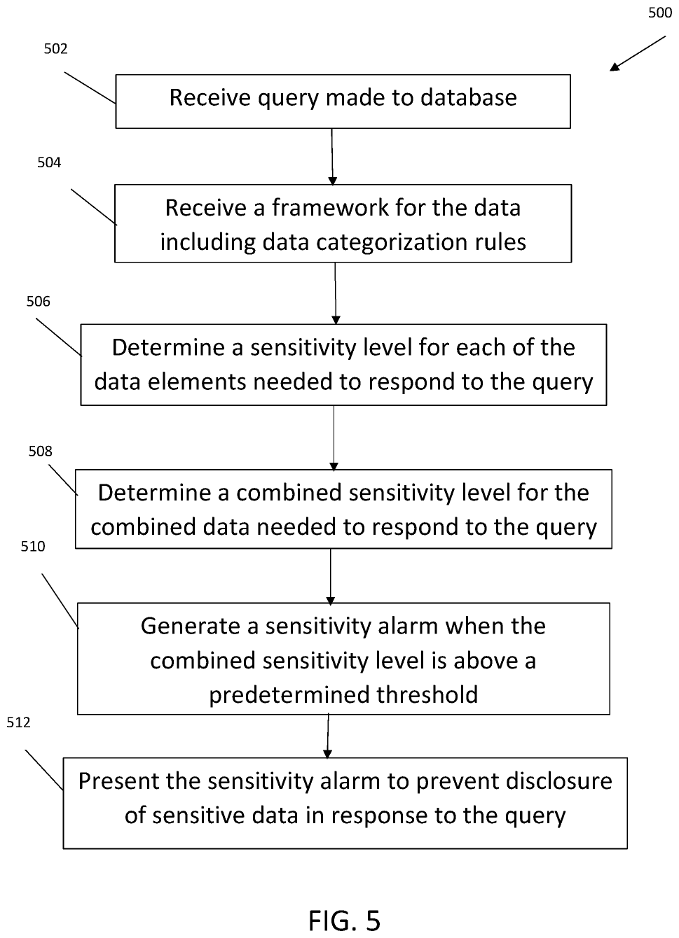

FIG. 5 illustrates an example of a process or method 500 that may be carried out by systems described herein, configured to prevent disclosure of sensitive data having a sensitivity above a sensitivity threshold, consistent with embodiments of the invention. The process 500 begins in 502 by the computing device 102 receiving a query directed to the database. The query may be received at the computing device 102 from the database 106, or the computing device 102 may receive the query directly from the client device 106. In various embodiments, the query may be an SQL query.

In 504, a framework, including data categorization rules for the data in the database 106, is received by the computing device 102. The framework may include elements other than the data categorization rules. For example, the framework may also include. In some embodiments, more than one framework may be received by the computing device 102, and each of the frameworks may have different categorization rules.

In 506, the computing device 102 may determine a sensitivity level for each of one or more data elements needed to respond to the query based on the categorization rules. Alternatively, the data elements may each have a predetermined sensitivity level stored in the database in association with the corresponding data element, and the predetermined sensitivity level may be obtained by the computing device in response to receiving the query.

In 508, the computing device 102 may determine a combined sensitivity level for the combined data from the data elements needed to respond to the query. The combined sensitivity level is determined from which data elements the query is applicable to and from the categorization rules in the framework or frameworks applicable to the query.

In 510, the computing device 102 may generate a sensitivity alarm when the combined sensitivity level is above a predetermined sensitivity level threshold. The sensitivity alarm may be in the form of a message or other type of alarm.

In 512, the computing device 102 may present the sensitivity alarm to prevent disclosure of sensitive data in the response to the query. The sensitivity alarm may be presented to the database, or to an administrator or other entity associated with the database. The sensitivity alarm may be presented in any known manner, such as an indicator on a graphic user interface, a message such as an email or instant message, etc. In some embodiments, the sensitivity alarm may be configured to prevent the response to the query from being sent until some action is taken.

It should be noted that the term “approximately” or “substantially” may be used herein and may be interpreted as “as nearly as practicable,” “within technical limitations,” and the like. In addition, the use of the term “or” indicates an inclusive or (e.g., and/or) unless otherwise specified.

Other implementations of the techniques herein will be apparent to those skilled in the art from consideration of the specification and practice of the embodiments disclosed herein. It is intended that the specification and various embodiments be considered as examples only.

What is claimed is:

1. A computer-implemented method for identifying a risk level of data in a response to a query made to a database, the method comprising:
receiving, by a computing device, the query;
receiving, by the computing device, a framework including data categorization rules for the data;
parsing the query to determine queried tables of data elements in the database;
classifying the data elements in the queried tables based on the data categorization rules in the framework to produce classification labelings for the data elements in each of the queried tables;
jointly classifying a union of data elements in the queried tables to produce a classification labelings for the union of data elements;
determining a risk level R(Q) for each of the queried tables by comparing the classification labelings for data elements in each table to the classification labelings in the union of data elements; and
presenting a risk level alert for the query when the risk level R(Q) of any of the queried tables is above a predetermined risk level.

2. The computer-implemented method of claim 1, further comprising preventing generation of the response to the query when the risk level R(Q) of any of the queried tables is above the predetermined risk level.

3. The computer-implemented method of claim 1, further comprising generating a differential risk level ΔR(Q)=R(Q)−Max(R(T₁), R(T₂), . . . , R(Tₙ)), where R(Tₙ) is a risk level for an n-th queried table.

4. The computer-implemented method of claim 3, wherein presenting the risk level for the query comprises presenting the risk level alert when the differential risk level ΔR(Q) is above a predetermined differential risk level.

5. The computer-implemented method of claim 1, wherein the risk level R(Q) comprises a sensitivity level of exposure of data in the data elements.

6. The computer-implemented method of claim 5, further comprising determining a sensitivity level for each of the data elements needed to respond to the query based on the data categorization rules.

7. The computer-implemented method of claim 1, wherein the risk level alert is configured to be produced in a message format.

8. A system for identifying a risk level of data in a response to a query made to a database, the system comprising:
a processor; and
a non-transitory memory coupled to the processor, the non-transitory memory storing instructions, which when executed by the processor, cause the processor to perform operations comprising:
receiving the query;
receiving a framework including data categorization rules for the data;
parsing the query to determine queried tables of data elements in the database;
classifying the data elements in the queried tables based on rules in the data categorization framework to produce classification labelings for the data elements in each of the queried tables;
jointly classifying a union of data elements in the queried tables to produce a classification labelings for the union of data elements;
determining a risk level R(Q) for each of the queried tables by comparing the classification labelings for data elements in each table to the classification labelings in the union of data elements; and
presenting a risk level alert for the query when the risk level R(Q) of any of the queried tables is above a predetermined risk level.

9. The system of claim 8, wherein the processor is further configured to cause operations including preventing generation of the response to the query when the risk level R(Q) of any of the queried tables is above the predetermined risk level.

10. The system of claim 8, wherein the processor is further configured to cause operations including generating a differential risk level ΔR(Q)=R(Q)−Max(R(T₁), R(T₂), . . . , R(Tₙ)), where R(Tₙ) is a risk level for an n-th queried table.

11. The system of claim 10, wherein presenting the risk level alert for the query comprises presenting the risk level alert when the differential risk level ΔR(Q) is above a predetermined differential risk level.

12. The system of claim 8, wherein the risk level R(Q) comprises a sensitivity level of exposure of data in the data elements.

13. The system of claim 12, wherein the processor is further configured to cause operations including determining a sensitivity level for each of the data elements needed to respond to the query based on the data categorization rules.

14. The system of claim 8, wherein the risk level alert is configured to be produced in a message format.

15. A non-transitory computer-readable medium storing instructions which, when executed by a processor of a system, cause the system to performing operations for identifying a risk level of data in a response to a query made to a database, the operations comprising:
receiving the query;
receiving a framework including data categorization rules for the data;
parsing the query to determine queried tables of data elements in the database;
classifying the data elements in the queried tables based on the data categorization rules in the framework to produce classification labelings for the data elements in each of the queried tables;
jointly classifying a union of data elements in the queried tables to produce a classification labelings for the union of data elements;
determining a risk level R(Q) for each of the queried tables by comparing the classification labelings for data elements in each table to the classification labelings in the union of data elements; and
presenting a risk level alert for the query when the risk level R(Q) of any of the queried tables is above a predetermined risk level.

16. The non-transitory computer-readable medium of claim 15, wherein the instructions further cause the system to prevent generating the response to the query when the risk level R(Q) of any of the queried tables is above the predetermined risk level.

17. The non-transitory computer-readable medium of claim 15, wherein the operations further comprise generating a differential risk level ΔR(Q)=R(Q)−Max(R(T₁), R(T₂), . . . , R(Tₙ)), where R(Tₙ) is a risk level for an n-th queried table.

18. The non-transitory computer-readable medium of claim 17, wherein presenting the risk level alert for the query comprises presenting the risk level alert when the differential risk level ΔR(Q) is above a predetermined differential risk level.

19. The non-transitory computer-readable medium of claim 15, wherein the risk level R(Q) comprises a sensitivity level of exposure of data in the data elements.

20. The non-transitory computer-readable medium of claim 19, wherein the operations further include determining a sensitivity level for each of the data elements needed to respond to the query based on the data categorization rules.

21. The non-transitory computer-readable medium of claim 17, wherein the risk level alert is configured to be produced in a message format.
